(19) United States
(12) Patent Application Publication
(10) Pub. No.: US 2021/0214872 A1
(43) Pub. Date: Jul. 15, 2021

(54) Processing technology of luminous and exothermic fabrics

(71) Applicant: Shishi Senke Intelligent Technology Co., Ltd., Fujian (CN)

(72) Inventor: Shanpao WANG, Fujian (CN)

(21) Appl. No.: 16/762,173

(22) PCT Filed: Jan. 23, 2019
(86) PCT No.: PCT/CN2019/072758

§ 371 Date: May 7, 2020

(30) Foreign Application Priority Data
Dec. 19, 2018 (CN) 201811557670.8

(51) Int. Cl. D05C 5/04; F21V 8/00; F21V 33/00; D05C 7/08; D05C 17/00

(52) U.S. Cl. CPC D05C 5/04; G02B 6/001; F21V 33/0008; D10B 2501/06; D05C 17/00; D05D 2303/42; D05C 7/08

(57) ABSTRACT

A processing technology of a luminous and exothermic fabric. The luminous and exothermic fabric comprises a base fabric and luminous or exothermic lines. The luminous or exothermic lines are embroidered on the base fabric by a coiling computer embroidery machine using the coiling-embroidery technology. The luminous or exothermic lines are one or more combinations of optical fiber, TPU luminous lines, LED light string lines, RGB light string lines, carbon fiber heat-conducting lines, graphene heat-conducting lines, or metal heat-conducting lines. The processing technology uses the computer embroidery machine to fix the luminous or exothermic lines on the fabric with the above-mentioned coiling-embroidery technology with better fixing effect, high efficiency mechanical work, high yield of good products, easy mass production, greatly reducing the production cost and fabric materials cost, less restriction, higher deformability, complicated pattern embroidered directly, and better luminous and exothermic effects.

### BACKGROUND OF THE INVENTION

The present invention relates to the field of a processing technology of a fabric having luminous and exothermic effects.

With the change of fashion trends, nowadays, some daily necessities, such as shoes and clothes, luggage and bags, etc., cannot meet the individual requirements of some young people in our lives, if these products only have their own use functions and appearance effects. For example, the fabric products involved in this case can achieve the luminous and/or exothermic effects, which can enhance the appearance effect of the products, and make them more interesting, personalized, and attractive.

At present, the common means for achieving the luminous and exothermic effects on fabrics (leathers, cloths, etc.) is fixing luminous and exothermic components (the luminous or heat-conducting materials commonly used on fabrics include optical fibers, luminous light strips, carbon fibers, heat-conducting filaments, etc.) on the fabrics with the structures handled and set on the fabrics. The luminous and exothermic components can be arranged to form a pattern, and the disclosed fixing methods are multiple methods, for example, perforation, gluing, hand sewing, rivet fixing, etc. However, some of these existing methods are not easy to operate, some are easily to be destroyed due to weak connections, and some can affect the luminous and exothermic effects for the application of the luminous and exothermic components with different materials and structures. Such as the application of optical fibers. The optical fiber is made of glass or plastic, and can achieve light transmission. The unique luminous effect can be achieved by guiding the transmission light to pass through the patterns constructed by the optical fibers. Due to its material characteristics, currently some knitted fabrics cannot directly be knitted with the optical fibers. The optical fibers can be blend into the fabrics by the perforation method at most when the fabrics are being knitted, but this method largely restricts the patterns to be constructed by the optical fibers, resulting in only obtaining some simple horizontal and vertical patterns, and also affects the light-guiding effect and structure arrangements.

### BRIEF SUMMARY OF THE INVENTION

### Technical Problem

When the existing processing technologies of the fabrics with a luminous and exothermic effects are applied on the optical materials, such as optical fibers, luminous light strips etc., or heat-conducting materials, such as carbon fibers, heat-conducting filaments, etc., there are many disadvantages, for example, the processing technologies greatly restrict the combined shapes constructed by the luminous and exothermic components, and greatly limit the patterns constructed by the materials with different thickness; the arrangement is relatively simple, the luminous and exothermic effects of the products are weak, the weaving cost is high, the yield of good products is low, it is difficult to achieve mass production, and other issues.

### Technical Solutions

The technical solution of the present invention is a processing technology of a luminous and exothermic fabric, the luminous and exothermic fabric comprises a base fabric and luminous or exothermic lines, and the luminous or exothermic lines are embroidered on the base fabric by a coiling computer embroidery machine using the coiling-embroidery technology.

The luminous or exothermic lines are one or more combinations of optical fiber, TPU luminous lines, LED light string lines, RGB light string lines, carbon fiber filament heat-conducting lines, graphene heat-conducting lines, or metal heat-conducting lines.

The coiling-embroidery technology comprises the following steps: 1. editing and making the computer embroidery pattern and compiling it into a embroidery program by using a computer embroidery template-making software of the computer embroidery machine; 2. importing the embroidery program data of step 1 into the computer embroidery machine, and completing the preparation work before starting the computer embroidery machine to start the coiling-embroidery work; and 3. starting the computer embroidery machine and performing the coiling-embroidery work according to the imported embroidery program. The computer embroidery machine in the step 2 uses a single-needle type headpiece for performing the coiling-embroidery work, the needle model of the single-needle headpiece is 7#, 9# or 11#, and the spindle speed during single-needle headpiece is working is 500-1000 r/min.

The luminous or exothermic lines are optical fibers. The coiling-embroidery technology comprises the following steps: 1. editing and making the computer embroidery pattern and compiling it into the embroidery program by using the computer embroidery template-making software of the computer embroidery machine; 2. importing the embroidery program data of step 1 into the computer embroidery machine, and completing the preparation work before starting the computer embroidery machine to start the coiling-embroidery work; and 3. starting the computer embroidery machine and performing the coiling-embroidery work according to the imported embroidery program. When the computer embroidery pattern is edited in the step 1, the curve of the filament track of the luminous or exothermic line corresponding to the embroidery work is an arc curve, and the radius of the arc curve is 5-10 times the diameter of the luminous or exothermic line. The computer embroidery pattern in the step 1 comprises a optical fiber reserved filament region. The optical fiber reserved region pulls out multiple sections of the optical fiber back and forth during the coiling-embroidery work in step 3. Each section is referred to as a reserved section. The reserved section is fixed at a fixation point with an embroidery line when being pulled out.

After completing the coiling-embroidery work in the step 3, the reserved section processing is performed. The processing steps are as follows: 1) fixing the point detached from the embroidery line at the reserved sections, 2) furling and gathering the multiple reserved sections into a bundle and forming a optical fiber bundle, 3) trimming the outer end of the optical fiber bundle with a trimming tool, 4) fusing and connecting the outer end of the optical fiber bundle by a fusion apparatus, and 5) putting the fused optical fiber bundle into a light-gathering tube.

The fusion apparatus in the step 4) is an aluminum block heating fusion apparatus. The fusion temperature of the aluminum block heating fusion apparatus is 200-220° C. The light-gathering tube in the step 5) is shrunk and fixed onto the optical fiber bundle by hot air, and the hot air shrinkage temperature is 150-180° C.

After trimming the outer end of the optical fiber bundle in the step 3), the remaining length of the reserved section is 20-100 mm.

The computer embroidery machine in the step 2 uses a single-needle type headpiece for performing the coiling-embroidery work. The needle model of the single-needle headpiece is 7#, 9# or 11#, and spindle speed during single-needle headpiece is working is 500-1000 r/min.

The computer embroidery pattern in the step 1 is coiling-embroidered by a optical fiber or one formed by multiple optical fibers, and the optical fiber bundle is one or more bundles.

The luminous or exothermic lines are LED light string lines, RGB light string lines, carbon fiber heat-conducting lines, graphene heat-conducting lines, or metal heat-conducting lines. The computer embroidery pattern in the step 1 comprises an electrode lead region. The electrode lead region pulls out the electrode lead sections at both ends of the luminous or exothermic lines during the coiling-embroidery work in the step 3, and the electrode lead sections are fixed by the embroidery lines.

Alternatively, the luminous or exothermic lines are TPU luminous lines or the optical fibers. The computer embroidery pattern in the step 1 comprises a light-guiding section region. The light-guiding section region pulls out the light-guiding section of the light source at the end of the luminous or exothermic line during the coiling-embroidery work in the step 3, and the light-guiding section of the light source is fixed by the embroidery lines.

### BENEFICIAL EFFECT

The beneficial effects of the present invention are shown below. By fixing the luminous or exothermic lines on the fabric with the computer embroidery machine and the above-mentioned coiling-embroidery technology, the fixation effect is better, the mechanical work efficiency is high, the yield of good products is high, and mass production is easy. Moreover, by using the above-mentioned technology, production can be carried out without complicated textile machines and production processes, therefore, not only the production cost but also the fabric material cost can be greatly reduced. Furthermore, because the above-mentioned technology aims at the application of special materials, it can encourage the material to suffer less restriction and higher plasticity, and the embroidery shapes and patterns not only can be obtained as simple geometric figures, but also can be directly embroidered as complicated patterns, thereby achieving the luminous and exothermic effects, greatly enhancing the luminous effect and the exothermic effect of the products, and also providing more extensive application fields and product types.

The materials used as above-mentioned luminous or exothermic lines are special optical fibers. The existing coiling-embroidery technology cannot be directly applied to the coiling-embroidery of the optical fiber, otherwise it will directly cause damage to the surface of the optical fibers and easy to break. In addition, the existing coiling-embroidery technology cannot complete embroidering more complicated patterns yet. However, by using the further technology of the present invention, the coiling-embroidery work using optical fibers can be easier, smoother and more stable, the tendency of filament-broken is low, the damage to the optical fibers during the coiling-embroidery work can be avoided greatly, and the optical fibers can achieve the better light-guiding effect.

### BRIEF DESCRIPTION OF THE DRAWINGS

FIG. 1 and FIG. 2 is a schematic diagram of different steps of the technology for processing the computer embroidery pattern on the luminous and exothermic fabric according to the present invention;

FIG. 3 is a schematic diagram of applying a luminous and exothermic fabric to clothing according to the present invention.

### DETAILED DESCRIPTION OF THE INVENTION

In order to further explain the technical solution of the present invention, the technical solution of the present invention is described in detail with several specific examples below.

The disclosed embodiment 1 of the processing technology of the luminous and exothermic fabric according to the present invention is as follows. The luminous and exothermic fabric comprises the base fabric and the luminous or exothermic lines. The base fabric may be the fabric penetrated by machine needles, such as leather, fabric and the like. The luminous or exothermic lines may be passive luminous lines, such as PU luminous lines, LED light string lines, RGB light string lines and the like, and may also be passive exothermic lines, such as carbon fiber filament heat-conducting lines, graphene heat-conducting lines, metal heat-conducting lines and the like. Herein, the passive luminous lines and the passive exothermic lines refer to the luminous or exothermic lines which do not directly generate light or heat by itself, but generate light or heat with electrical power provided by a power source through a circuit structure. Since suitable active luminous materials have not been found yet, they are not listed. However, if there are such material lines, the technology of the present invention can also be applied, and it is within the protection scope of the present invention. Next, it will describe that the luminous or exothermic lines are embroidered on the base fabric by using coiling-embroidery technology with the coiling computer embroidery machine. The coiling-embroidery technology steps of the present invention will be described in detail below.

The coiling-embroidery technology comprises the following steps:

Steps 1: The computer embroidery pattern is edited by the computer embroidery template-making software of the computer embroidery machine, and compiled into the embroidery program. At present, the more specific details is as follows: firstly, the template is made after determining the size of the luminous and exothermic pattern of the product, and the pattern size of the product to be embroidered is determined according to the tread pattern presented by the design pattern; and then, the computer embroidery pattern is edited according to the determined size dimension by using the computer embroidery template-making softer ware (embroidery CAD), the template (i.e. the embroidery program) is produced and exported after checking in detail.

Step 2: The embroidery program data of the step 1 is imported into the computer embroidery machine, and the preparation work is completed before starting the coiling-embroidery work of the computer embroidery machine. The preparation work comprises: relevant work parameters of the computer embroidery machine is set; the materials and types of the embroidery lines and the bottom lines are selected according to the design of the computer embroidery pattern, and the embroidery lines and the bottoms lines are threaded through the embroidery line machine needle and the bottom line spindle shell of the computer embroidery machine, respectively; the embroidery lines are threaded through the embroidery line machine needle; and setting the bottom line are threaded through spindle shell of the bottom line computer embroidery machine; the luminous or exothermic lines are threaded through the coiling-swing mechanism of the computer embroidery machine, the cloth lining paper and the base fabric are fixed on the computer embroidery machine, the size dimension of the embroidery is checked, the embroidery-starting point is setted within the embroidery frame limited range.

Due to the characteristic of several luminous or exothermic line materials disclosed above in the present embodiment, is different from the common line materials used in coiling-embroidery and other embroidery, it is preferred to use the single-needle headpiece for performing the coiling-embroidery work. The headpiece is a special embroidery headpiece that can be used exclusively for the use of special materials in this case. This case aims at protecting the technology, thus, the structure of the headpiece is not disclosed in this case, and claimed for patent protection in other case. Moreover, due to the characteristic of the line materials, preferably, the needle model of the single-needle headpiece can be 7#, 9# or 11#, and the spindle speed can be in the range of 500-1000 r/min during the single-needle headpiece working. After the test operation, it shows that if the spindle speed is lower than that range, the work efficiency is low; and if the spindle speed is higher than that range, the work is unstable and it is easy to cause damage. By using the above-mentioned machine needle model and providing the spindle speed within the range, the coiling-embroidery work can be more stable, more rapid and smoother, and it is not easy to cause damage to the luminous and exothermic lines. It can analyze and obtain better parameter values for the specific value and the setting of other parameters according to the actual selected materials and factors such as width, characteristics and so on, and it is not described herein.

Step 3: the computer embroidery machine is started to perform the coiling-embroidery work according to the imported embroidery program. The detail is as follows: the start switch is turned on, firstly, the rod is pulled to starting embroider after performing the limit check and resetting the M axis to zero. Under the control of the embroidery program, the coordinate values of the computer embroidery pattern is converted to the electrical signal of the displacement value in the X and Y direction of the stretch frame of the embroidery machine, the electrical signal is sent to the X, Y, and Z single-chip microcomputer system for performing the treatment of motor speed up and down, a three-phase six-beat signal is output, the power amplifier box of the line motor performs the power amplification, the stretch frame is driven by the red X and Y stepper motor for completing the feeding movement between X and Y; Z stepper motor is driven in the meantime, and the machine needle is driven to move up and down by the Z stepper motor, thereby continuously performing the embroidery for fixing the trend of optical fibers; the Z stepper motor drives the headpiece transmission mechanism to rotate through the synchronous toothed belt and the like, the special mechanism of the headpiece drives the lead mechanism and the needle, together with the thread, to move up and down and to pierce the fabric; the rotary shuttle rotates in the line-hooking mechanism so that the embroidery lines pass around the spindle shell with the bottom line hidden therein; the thread-taking-up mechanism moves to convey the embroidery line, tighten the stitches, and prepare the embroidery line section for the next stitch; the coiling mechanism drives the optical fibers to perform the angular position move and swing, thereby avoiding the machine needle directly piercing the optical fibers; the machine needle drives the embroidery lines to fix the luminous or exothermic lines through the left and right reciprocating puncture, the X and Y stepper motor drive the stretch frame and the base fabric to perform plane motion through the synchronous toothed belt and other mechanisms; each stitch point to be embroidered on the base fabric is sent to the machine needle for embroidery, the speed of the up and down movement of the machine needle is coordinated with the moving direction, moving amount and moving speed of the stretch frame, in order to twist the embroidery line and the bottom line, and a double-lock stitch is formed on the base fabric; and coiling-embroidery is continuously performed in this way to complete the computer embroidery pattern.

Since the luminous or exothermic lines mentioned above are the passive luminous or exothermic lines, it is necessary to connect the luminous or exothermic energy source at the ends of the lines, especially for the above-mentioned LED light string lines, RGB light string lines, carbon fiber filament heat-conducting lines, graphene heat-conducting lines and metal heat-conducting lines. These lines have luminous or exothermic components themselves, thus, the energy source connected to the end of the lines is electrical power, so that, for these materials, the computer embroidery pattern in above-mentioned step 1 comprise the electrode leader region. The electrode lead region pulls out the electrode lead section at the two ends of the luminous or exothermic lines during the coiling-embroidery work in the step 3. The electrode lead section can be fixed with the embroidery lines. After completing fabric-embroidery and before or after making products, the electrode lead section can be connected to the control circuit module and the power supply driving the lines to generate light or heat. As for the TPU luminous line, the line does not have luminous component itself, but can achieve a physical light-guiding effect by connecting light source to the end of the line, thereby achieving the luminous effect. Thus, as for this material, the computer embroidery pattern in step 1 comprises a light-guiding section region. The light-guiding section region pulls out the light source light-guiding section which is at the end of the luminous or exothermic line during the coiling-embroidery work in the step 3, and the light source light-guiding section is fixed with the embroidery line.

By using the above-mentioned materials, the luminous effect achieved can be used to design the program of the light-emitting-related part in the control circuit module according to the pattern design, and the exothermic effect achieved can be used to design the program of the heat-generating-related part in the control circuit module according to the pattern design and heat-generating requirement. Moreover, according to practical applications, preferably, the voltage and temperature for light-emitting or heating of the products should be set in a value range of safe and energy-saving use. For example, for some daily necessities, the voltage value is preferably 3.7-12V and the heating temperature is 24-100° C.

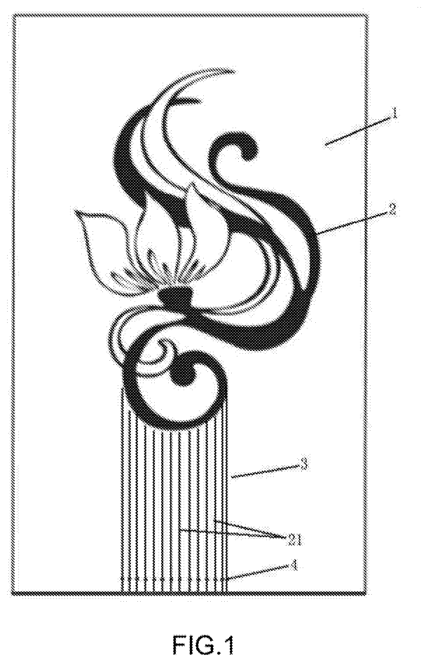

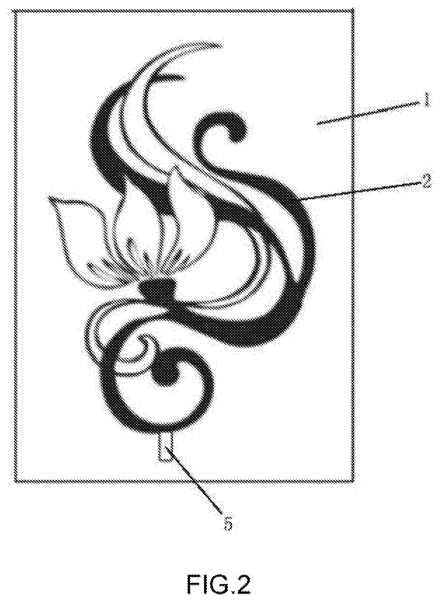

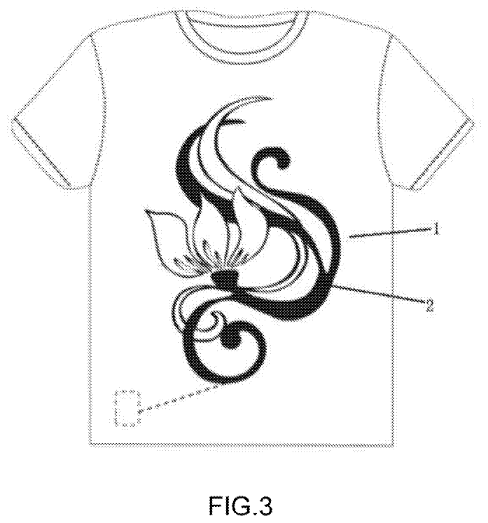

According to the embodiment 2 of the processing technology of the luminous and exothermic fabric of the present invention, as shown in FIG. 1-3, the luminous and exothermic fabric comprises a base material 1 and luminous or exothermic lines 2. The base material 1 can be a fabric penetrated by machine needles, such as leather, cloth and the like. The luminous or exothermic lines are optical fibers. The optical fibers are different from the above-mentioned passive luminous materials. The optical fibers do not have luminous components themselves, and the physical characteristic of guiding light is mainly used herein. The coiling-embroidery technology in this embodiment is basically similar to that in above-mentioned embodiment 1, but due to the material and optical conditions, there are some differences compared to the above-mentioned embodiment 1, and it will be described below in detail.

Firstly, as for the pattern shown in the figure, when the computer embroidery pattern is edited in the above-mentioned step 1, the curve of the luminous or exothermic line during the corresponding embroidery work is an arc curve, and the radius of the arc curve is 5-10 times the diameter of the luminous or exothermic lines. For example, if the diameter of the optical fibers is 0.25 mm, the radius of the arc curve corresponding to the computer embroidery pattern should be 1.25-2.5 mm, so that, the bending angle of the optical fibers can transmit light well. It should be noted that the right-angle curve should be avoided, because the right-angle curve will not be able to continuously transmit light. In addition, due to using the optical fibers, it is necessary to provide the starting point of the light source for guiding light, so that the computer embroidery pattern in the above-mentioned step 1 comprises a optical fiber reserved filament region 3. The optical fiber reserved filament region 3 draws back and forth so as to pull out multiple sections of optical fibers during the coiling-embroidery work in step 3. Each section is referred to as a reserved section 21, which is to be processed later as the starting point for the guiding light source. The reserved section 21 is fixed at a fixation point 4 by the embroidery line when it is pulled out. The remaining length of the reserved section 21 is the preset length of the embroidery program. The reserved section 21 needs to be processed later, and a looser state is required during processing, therefore, it is not appropriate to fix the whole section with the embroidery line. Here, the effect of fixing at the fixation point 4 is to prevent the reserved section 21 from having a longer length and being looser, which is easily to be hook so as to affect the coiling-embroidery work or other situations.

As for the setting range of the spindle speed of the headpiece and several optional needle models in the above-mentioned embodiment 1 are suitable for the optical fiber, specifically and can be selected according to the thickness of the optical fiber and the material properties thereof. For example, during the test of the technical solution of the present embodiment, optical fibers with a diameter of 0.25 m is selected, the preferred spindle speed of the headpiece is 750 r/min, and the machine needle is 11#, so that, the work is stable and the filament is not easy to break.

After completing the embroidery work in step 3 of embodiment 1, the reserved section 21 is processed. The processing steps are as follows. 1) The reserved section 21 is detached from the fixation point of the embroidery line. Here, detaching from the fixation point of the embroidery line can be cutting off the embroidery line or directly pulling the end of the reserved section 21 out of the embroidery line at the fixation point 4. In addition, because the reserved section 21 is pulled back and forth, the reserved sections 21 may be connected to each other, so that, it can also directly cut off the lines connecting the two reserved section and then pull out the embroidery line at the fixation point 4. 2). The multiple reserved sections 21 are furled and gathered into a bundle to form a optical fiber bundle, that is, the multiple reserved sections 21 are furled into a optical fiber bundle wrapped and tied at a predetermined direction by lines. 3). The outer end of the optical fiber bundle can be trimmed with the trimming tool. A U-shaped scissor can be used as the trimming tool for trimming. After trimming, the remaining length of the reserved section 21 is preferably 20-100 mm, which is beneficial to guide light, and also to stabilize structural settings, and preferably 40-45 mm. The remaining length can also be determined according to the actual product design. 4) The outer ends of the optical fiber bundles are fused and connected together by a fusion apparatus, that is, the end of the trimmed optical fiber bundle is heated, fused and smoothed. The fusion apparatus disclosed in the present embodiment is the aluminum block heating fusion apparatus. The fusion temperature of the aluminum block heating fusion apparatus is 200-220° C. The operation is simple and convenient. The fusion is smooth, which is beneficial to the light-guiding at the starting point of the optical fibers. 5) The fused optical fiber bundle is put into the light-gathering tube 5. The light-gathering tube 5 disclosed in this embodiment is shrunk and fixed onto the optical fiber bundle by hot air. The hot air-shrinking temperature is 150-180° C., which has a good shrinking and fixing effect and does not interfere with the optical fiber bundle.

As the name implies, the above-mentioned light-gathering tube 5 has the function of gathering light. After processing the reserved section 21 and completing fabric-embroidery, and before or after making the product, the light-gathering tube 5 will be installed with lamp beads, and connected to the control circuit module and power supply driving the lamp beads to emit light. The luminous effect can be achieved by designing the program of light-emitting-related part in the control circuit module according to the pattern design.

In the present embodiment, the computer embroidery pattern described in the step 1 can be coiled and embroidered with a single optical fiber or one formed by multiple optical fibers. That is, the optical fiber is not interrupted during the coiling-embroidery work until completing pattern-embroidery, and there is no need to set another embroidery point in midway. In addition, whether the embroidery is performed with one or more optical fibers, the optical fiber bundle can be one or more bundles. Different light-gathering tube 5 can has lamp beads with different colors, so as to transmit light with different colors, which is beneficial to achieve the pattern effect diversity.

1: A processing technology of a luminous and exothermic fabric, the luminous and exothermic fabric comprising a base fabric and luminous or exothermic lines, characterized in that: The luminous or exothermic lines are embroidered on the base fabric by a coiling computer embroidery machine using the coiling-embroidery technology.

2: The processing technology of the luminous and exothermic fabric according to claim 1, characterized in that: The luminous or exothermic lines are one or more combinations of optical fiber, TPU luminous lines, LED light string lines, RGB light string lines, carbon fiber filament heat-conducting lines, graphene heat-conducting lines, or metal heat-conducting lines.

3: The processing technology of the luminous and exothermic fabric according to claim 2, characterized in that: The coiling-embroidery technology comprises the following steps: 1. editing and making the computer embroidery pattern and compiling it into a embroidery program by using a computer embroidery template-making software of the computer embroidery machine; 2. importing the embroidery program data of step 1 into the computer embroidery machine, and completing the preparation work before starting the computer embroidery machine to start the coiling-embroidery work; and 3. starting the computer embroidery machine and performing the coiling-embroidery work according to the imported embroidery program. The computer embroidery machine in the step 2 uses a single-needle type headpiece for performing the coiling-embroidery work, the needle model of the single-needle headpiece is 7#, 9# or 11#, and the spindle speed during single-needle headpiece is working is 500-1000 r/min.

4: The processing technology of the luminous and exothermic fabric according to claim 1, characterized in that: The luminous or exothermic lines are optical fibers. The coiling-embroidery technology comprises the following steps: 1. editing and making the computer embroidery pattern and compiling it into the embroidery program by using the computer embroidery template-making software of the computer embroidery machine; 2. importing the embroidery program data of step 1 into the computer embroidery machine, and completing the preparation work before starting the computer embroidery machine to start the coiling-embroidery work; and 3. starting the computer embroidery machine and performing the coiling-embroidery work according to the imported embroidery program. When the computer embroidery pattern is edited in the step 1, the curve of the filament track of the luminous or exothermic line corresponding to the embroidery work is an arc curve, and the radius of the arc curve is 5-10 times the diameter of the luminous or exothermic line. The computer embroidery pattern in the step 1 comprises a optical fiber reserved filament region. The optical fiber reserved region pulls out multiple sections of the optical fiber back and forth during the coiling-embroidery work in step 3. Each section is referred to as a reserved section. The reserved section is fixed at a fixation point with an embroidery line when being pulled out.

5: The processing technology of the luminous and exothermic fabric according to claim 4, characterized in that: After completing the coiling-embroidery work in the step 3, the reserved section processing is performed. The processing steps are as follows: 1) fixing the point detached from the embroidery line at the reserved sections, 2) furling and gathering the multiple reserved sections into a bundle and forming a optical fiber bundle, 3) trimming the outer end of the optical fiber bundle with a trimming tool, 4) fusing and connecting the outer end of the optical fiber bundle by a fusion apparatus, and 5) putting the fused optical fiber bundle into a light-gathering tube.

6: The processing technology of the luminous and exothermic fabric according to claim 5, characterized in that: The fusion apparatus in the step 4) is an aluminum block heating fusion apparatus. The fusion temperature of the aluminum block heating fusion apparatus is 200-220° C. The light-gathering tube in the step 5) is shrunk and fixed onto the optical fiber bundle by hot air, and the hot air shrinkage temperature is 150-180° C.

7: The processing technology of the luminous and exothermic fabric according to claim 5, characterized in that: After trimming the outer end of the optical fiber bundle in the step 3), the remaining length of the reserved section is 20-100 mm.

8: The processing technology of the luminous and exothermic fabric according to claim 5, characterized in that: The computer embroidery machine in the step 2 uses a single-needle type headpiece for performing the coiling-embroidery work. The needle model of the single-needle headpiece is 7#, 9# or 11#, and spindle speed during single-needle headpiece is working is 500-1000 r/min.

9: The processing technology of the luminous and exothermic fabric according to claim 8, characterized in that: The computer embroidery pattern in the step 1 is coiling-embroidered by a optical fiber or one formed by multiple optical fibers, and the optical fiber bundle is one or more bundles.

10: The processing technology of the luminous and exothermic fabric according to claim 3, characterized in that: The luminous or exothermic lines are LED light string lines, RGB light string lines, carbon fiber heat-conducting lines, graphene heat-conducting lines, or metal heat-conducting lines. The computer embroidery pattern in the step 1 comprises an electrode lead region. The electrode lead region pulls out the electrode lead sections at both ends of the luminous or exothermic lines during the coiling-embroidery work in the step 3, and the electrode lead sections are fixed by the embroidery lines; Alternatively, the luminous or exothermic lines are TPU luminous lines or the optical fibers. The computer embroidery pattern in the step 1 comprises alight-guiding section region. The light-guiding section region pulls out the light-guiding section of the light source at the end of the luminous or exothermic line during the coiling-embroidery work in the step 3, and the light-guiding section of the light source is fixed by the embroidery lines.
